(19) United States
(12) Patent Application Publication
(10) Pub. No.: US 2003/0025906 A1
(43) Pub. Date: Feb. 6, 2003

(54) Optical inspection of solder joints

(75) Inventor: Michael Sheffer, Givat Ela (IL)

Correspondence Address: Dr. Mark Friedman LTD., c/o Bill Pokinghorn Discovery Dispatch, 9003 Florin Way, Upper Marlboro, MD, 20772, US

(73) Assignee: BEAMWORKS LTD.

(21) Appl. No.: 09/922,165

(22) Filed: Aug. 6, 2001

(51) Int. Cl. G01N 21/00

(52) U.S. Cl. 356/237.5

(57) ABSTRACT

A new method of optical inspection of populated printed circuit boards (PCB), specifically of component leads and solder joints, is provided. At least a portion of the PCB being tested is illuminated with a beam of collimated light. A light detecting device detects specular reflection from the features being examined on the PCB for diagnostically useful patterns. For example, each properly soldered gull-wing lead produces three detectable reflections, each properly soldered J-type lead produces two detectable reflections, and each properly soldered rectangular lead produces one detectable reflection. Other PCB features produce other diagnostically useful reflections. An anomalous reflection indicates, for example, improper soldering or a misplaced component. The invention can be configured to inspect a plurality of leads simultaneously, allowing increased throughput.

### FIELD AND BACKGROUND OF THE INVENTION

The present invention relates to the optical inspection of electronic assemblies and, more specifically, to an improved method and an illumination device for optical inspection of integrated circuit boards, especially of components soldered onto the boards.

Modern electronic devices are most often constructed by installing electronic components onto a printed circuit board (PCB). The first step in the production of such an electronic device is the manufacture of a PCB. Conductive channels or wires are printed onto a non-conductive substrate. The conductive channels connect points on the PCB to the edge connector of the PCB or connect between points and make the circuits of the PCB.

After the circuits are printed, components are added to the PCB to give a populated PCB. Passive components, such as resistors and capacitors, and active components, such as integrated circuits, are attached to the board so that the leads of the components make electrical contact with the proper points of the circuit. Once all the components have been installed in the proper place, the printed circuitry interconnects the components to form the populated PCB that is the required electronic device.

As in any complex manufacturing process various faults occur. After assembly, a populated PCB must be checked, and while being checked is referred to as a UUT (Unit Under Test).

One method known in the art to inspect a UUT is AOI (Automatic Optical Inspection). In AOI, an optical imaging system is used to visually scan the UUT and, using computerized image processing techniques, the images found are compared to the expected UUT topography. Inspection includes seeking mounting errors to determine the presence or absence of electronic components, position deviation such as misalignment or tilting, orientation and polarity markings on individual components are read to confirm that the correct component is in place at a given location. Connections are examined for bent leads and short circuits. Solder connections are checked for excess or insufficient solder and for the presence of solder bridges. By scanning the UUT it is confirmed that the circuitry is not damaged or short-circuited.

For example, U.S. Pat. No. 4,988,202 discloses an AOI system for the determination of solder joint integrity. Multiple point light sources arrayed in different orientations illuminate an inspected solder joint. Based on the intensity of light reflected from various points on the solder surface, a three dimensional shape of the solder joint is calculated. The shape of the joint is compared with the shape of an ideal joint.

U.S. Pat. No. 5,064,291 discloses a method of inspecting solder joint connections by illuminating a solder joint sequentially from a plurality of angles and for each angle, detecting light reflected from the solder joint from a plurality of angles. The shape of the solder joint is calculated from these data and compared to the shape of an ideal solder joint.

A great disadvantage of these and other AOI systems known in the art is that for a rigorous inspection whereby the optical imaging system must scan virtually every detail of the UUT, much time is required, especially for UUTs having active components with a large number of small leads. If an AOI system is configured to examine a UUT quickly, subtle production faults remain undetected.

These and other AOI systems known in the art have a number of disadvantages. First, AOI systems must usually undergo a long learning process for each UUT. One or more “golden standard” UUTs undergo rigorous inspection to act as reference standards for actual inspections. This reduces throughput and flexibility when different types of UUTs need to be inspected by one AOI system. Further the systems require complex illumination and inspection hardware, in particular a plurality of high performance imaging devices.

For example, U.S. Pat. No. 5,105,149 discloses an AOI system for the inspection of ICBs using a plurality of optical imaging devices. A first camera rapidly performs a rough inspection of the UUT. Individual component leads that fail the rough scan and are suspected of being improperly soldered are illuminated by a laser and inspected carefully by an obliquely mounted camera capable of precisely measuring the shape of the joint.

U.S. Pat. No. 4,028,728 discloses the use of an optical imaging system to discriminate between different types of light-reflective surfaces on UUTs, specifically for the detection of soldering defects on populated PCBs. Differentiation of surfaces is based on detecting changes in polarity of light projected onto a reflecting surface.

The requirement for electronic devices with increasingly higher performance means that populated PCBs become compact and more densely populated with smaller and more complex components. The more compact design of populated PCBs reduces the effectivity of current AOI diagnostic systems due to the relatively slow scanning rates and the time required for analyzing the large amount of the optical image data. There is a need for an improved method for the optical inspection of compact and densely populated printed circuit boards, able to simultaneously optically inspect a plurality of leads and using minimal calculation power effectively identify improperly connected component leads.

### SUMMARY OF THE INVENTION

The above and other objectives are achieved by the inspection method and device provided by the present invention. The method and device of the present invention are general and can be easily configured to inspect a UUT based only on the theoretical topography of the UUT (such as supplied by a CAD description) and requires no long learning step. The method and device of the present invention can be easily adapted for the inspection of virtually any UUT.

Components, especially active components with a plurality of leads, are attached to a printed circuit board is by soldering using surface mount technology (SMT). In SMT a solder paste is applied to a number of solder pads corresponding to the number of component leads. An SMT component is placed on top of the circuit board so that each one of the leads rests over a corresponding solder pad on top of the layer of solder paste. The solder paste is heated (for example in a reflow oven or with a laser) until it forms a conductive and rigid physical connection between a solder pad and a respective component lead.

Any number of faults can occur during an SMT process. If any one of the component leads is bent upwards, that lead will not make effective contact with a respective solder pad. If any one of the component leads is bent downwards, that lead can make contact with a respective solder pad, but by lifting the entire component upwards, can prevent other leads from making contact with respective solder pads. Further, a component may be placed improperly or may shift before the heated solder sets, so that the component is improperly located relative to the rest of the circuit board components. This may lead to ineffective contact of one or more of the component leads with respective solder pads, or the component may interfere with the placement of other components.

The method and device of the present invention concern the optical inspection of UUTs and, more specifically, of soldered joints. In general, features on a UUT surface, such as component leads and solder joints, reflect light specularly, that is that the angle of reflection is equal to the angle of incidence. Thus, the method of the present invention is based on detecting specular reflection from surface features and in particular from the component leads and solder joint surfaces.

Collimated light is projected at a location being inspected at a selected first angle relative to the UUT and specularly reflected light is detected at a selected second angle relative to the UUT. In order to increase resolution and minimize the appearance of difficult-to-interpret and spurious detected light signals, it is preferable that light detectors that detect light coming from substantially a single unique direction, using a directional light detector such as a camera equipped with a telecentric lens be used. a priori, there is no reason that the first and second angles are not the same. The first and the second angles are selected so that the specularly reflected light which is detected forms an easy to identify and diagnostically useful pattern.

Specifically, each properly soldered lead is detected by the presence of distinct collinear bright spots of light. Absence or an excess of bright spot or lines, unusual or unexpected shapes of light indicate improper soldering. Due to the fact that the image detected is of bright entities, the light detecting device can be configured to detect light reflected from a plurality of leads simultaneously. Misalignment of rows of bright lights attributable to the specular reflection from the leads of a single component indicates that a component is misplaced.

For example, gull-wing leads give a pattern of light made up of three spots of light, J-type leads of two spots, and rectangular leads of one spot of light. When a plurality of leads of one component are illuminated, rows of spots are observed. Gull-wing leads give three parallel rows of spots, J-type leads two parallel rows of light, and rectangular leads one row of lights. Other component types and UUT features may give distinctive light patterns that are observable by the device and method of the present invention.

According to a feature of the present invention, the light source is configured to either illuminate only a portion of the surface of the UUT or the entirety of the UUT surface at one time. According to a feature of the present invention, in the former case there is included a mechanism to move the light detection system and the UUT relative to each other.

A feature of the present invention includes detection of reflected light traveling in parallel to the Z-axis of the UUT.

According to a still further feature of the present invention, the collimated light is projected at the UUT from a plurality of individual light sources, so that the UUT is illuminated from a plurality of directions. For example this can be from two, four, twenty or even more directions. Illumination can be concurrent or non-concurrent from all the directions. When illumination from each of the plurality of directions is not concurrent, according to a feature of the present invention illumination from each of the different directions occurs in succession.

Another feature of the present invention includes illumination of the UUT from above, in parallel to the Z-axis of the UUT and the light is reflected with a non-zero component perpendicular to the Z-axis. According to a still further feature of the present invention light reflected in a plurality of directions is detected.

Additional features of the present invention include that the only source of illumination of the UUT is the light source of the present invention. Thus the device of the present invention may include an enclosure to isolate the UUT from extraneous sources of light.

Herein the term “collimated light” is to be understood as a light beam wherein the rays of light making up the beam are substantially parallel, such as light that has passed through a collimating device.

### BRIEF DESCRIPTION OF THE DRAWINGS

The invention is herein described, by way of example only, with reference to the accompanying drawings, where:

FIG. 1 is a schematic depiction of a first embodiment of the device of the present invention used to inspect an SMT component with gull-wing leads;

FIG. 2A is a schematic depiction of a second embodiment of the device of the present invention used to inspect an SMT component with J-type leads;

FIG. 2B is a schematic depiction of a second embodiment of the device of the present invention used to inspect an SMT component with rectangular leads;

FIG. 3 is a schematic depiction of a third embodiment of the device of the present invention, where illumination of a UUT is performed from four quadrants;

FIG. 4 is a schematic depiction of a third embodiment of the device of the present invention, where illumination of a UUT is performed using an annular light source;

FIGS. 5A to 5J are depictions of images produced by the method of the present invention where:

FIG. 5A is a depiction of an image according to the prevent invention of a square-shapes component with gull-wing leads;

FIG. 5B is a depiction of an image according to the present inventions of a row of gull-wing leads where one gull-wing lead is upwardly bent;

FIG. 5C is a depiction of an image according to the present inventions of a row of gull-wing leads where one gull-wing lead is inwardly bent;

FIG. 5D is a depiction of an image according to the present inventions of a row of gull-wing leads where an excess of solder causes a short circuit between two leads;

FIG. 5E is a depiction of an image according to the present inventions of a row of gull-wing leads where one gull-wing lead has insufficient solder;

FIG. 5F is a depiction of an image according to the present inventions of a row of gull-wing leads where one gull-wing lead has an excess of solder;

FIG. 5G is a depiction of an image according to the present inventions of a row of gull-wing leads where one gull-wing lead is broken;

FIG. 5H is a depiction of an image according to the present inventions of a row of gull-wing leads of a component where the component is misaligned relative to the solder pads; and FIG. 5I is a depiction of an image according to the present invention of a component with rectangular leads.

### DETAILED DESCRIPTION OF THE INVENTION

Before turning to details of the present invention, it should be appreciated that the present invention provides a method of inspecting UUTs and in particular the integrity of component leads and solder on a populated PCB. Although the method of the present invention may be performed using a variety of devices, the inspection device of the present invention allows particularly effective performance of the method of the present invention.

The principles of the methods and operation of the inspection device according to the present invention are better understood with reference to the figures and the accompanying description. In the accompanying figures, like reference numerals refer to like parts throughout the figures. In the description below, a different lead type is examined by each of the different embodiments of the device of the present invention discussed. It is clear to one skilled in the art that all embodiments of the present invention, including the ones specifically discussed, are suitable for examining all the specifically described lead types as well as other features of UUTs not described specifically herein.

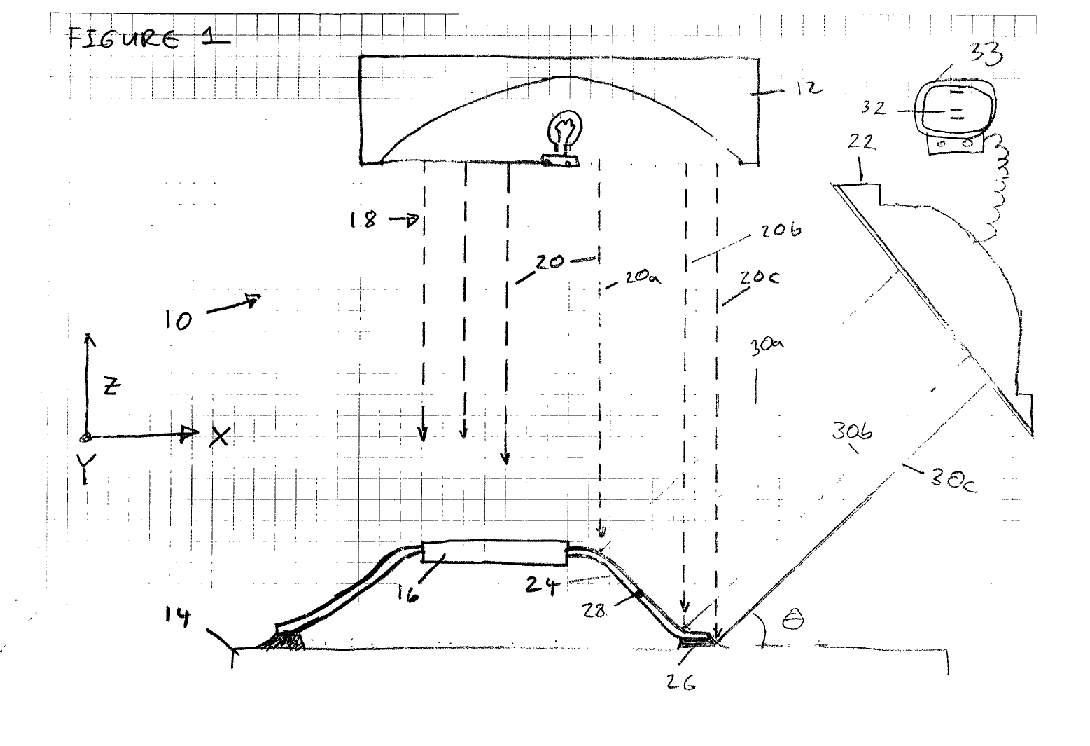

A first non-limiting embodiment of a device 10 of the present invention is depicted in FIG. 1. A source 12 of collimated light 18 illuminates a UUT 14, on which resides a SMT component 16 with gull-wing leads with light beam 18 made of individual incident light rays 20 (dashed arrows). In FIG. 1 and the other figures, the Z-axis is perpendicular to UUT 14 and the X-Y plane is parallel to the plane of UUT 14. In FIG. 1, light beam 18 is projected perpendicularly (parallel to the Z-axis) towards UUT 14. A light detector (such as a camera with a telecentric lens) 22 is mounted so as to view UUT 14 from an oblique angle Θ. Θ can be any angle between 1° and 80° from horizontal (the X-Y plane) to UUT 14. Θ is preferably between 30° and 60°, and even more preferably between 40° and 50° from horizontal to UUT 14.

In a preferred embodiment of the present invention, light beam 18 is substantially monochromatic. For example, a red diode laser emitting coherent light with a wavelength of 980 nm can be used as source of collimated light 12. Often, and especially when light beam 18 is substantially monochromatic, it is advantageous to configure light detector 22 to detect substantially only a limited range of wavelengths of light present in light beam 18. This can be implemented, for example, by placing an appropriate filter 23 or colored glass in such a way as to prevent background light from being detected by light detector 22. It is clear to one skilled in the art that the use of a substantially monochromatic light beam and a light detector configured to detect substantially exclusively light of the wavelength of the monochromatic light beam increases the sensitivity and accuracy of a device of the present invention.

Any light detector 22 can be used. A directional light detector, that is a light detector configured to only detect light coming from substantially a single unique direction is preferred. Examples of directional light detectors known in the art include a camera equipped with a telecentric lens, an appropriately configured line CCD, or an appropriately configured CMOS array detector. As is clear to one skilled in the art, the use of a directional light detector increases resolution and minimizes the appearance of difficult-to-interpret and spurious detected light signals.

Individual incident light rays 20 impinge on the surface of an SMT gull-wing lead 24 and solder joint 26. In general a gull-wing lead, such as lead 24, has a shape where the two terminal ends are parallel to UUT 14 and with one inflection point 28. Incident light rays, 20a and 20b impinging on lead 24 and 20c impinging on solder joint 26 are specularly reflected to produce reflected rays 30a, 30b and 30c, respectively (solid arrows). Since each point along the surface of gull-wing lead 24 is oriented at a different angle relative to collimated light beam 18, each reflected ray travels at a different angle relative to light beam 18. It is clear to one skilled in the art that any properly placed observer, such as light detector 22, detects two specularly reflected rays, 30a and 30b, when collimated light beam 18 is directed at gull-wing lead 24 from any angle between perpendicular to UUT 14 to perpendicular to inflection point 28. Further, a third ray 30c, produced by specular reflection of collimated light beam 18 impinging on solder joint 26 from any angle from perpendicular to substantially parallel to UUT, will be detected by that same observer. Thus, in FIG. 1, light detector 22 is oriented relative to light source 12 and UUT 14 so as to detect a pattern of three spots of light 32, produced by the specular reflection of light beam 18. In FIG. 1, pattern 32 is displayed using a suitable monitor 33.

Since the orientation of light source 12, the orientation of light detector 22 and the geometry of gull wing lead 24 are known, it is possible to predict the pattern of reflected light that is produced by a properly mounted component lead. As soon as detected pattern 32 deviates substantially from the expected pattern, it is concluded that lead 24 or that component 16 is improperly attached to UUT 14.

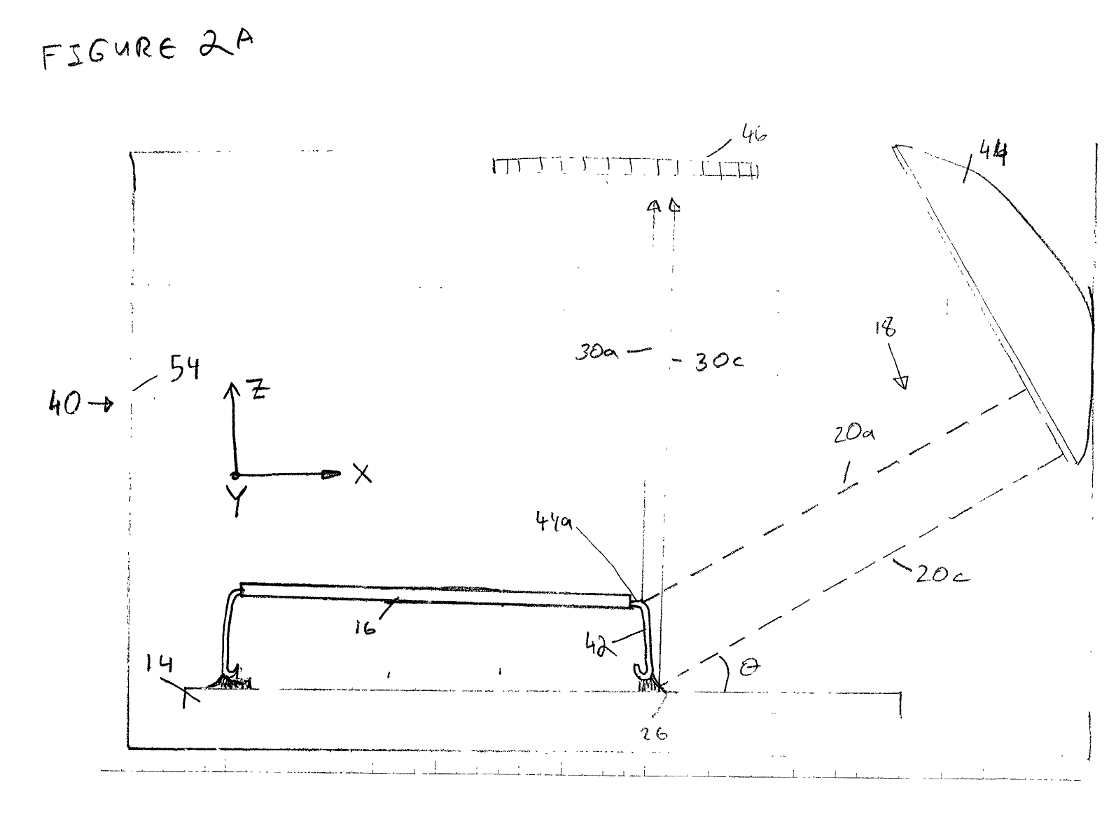

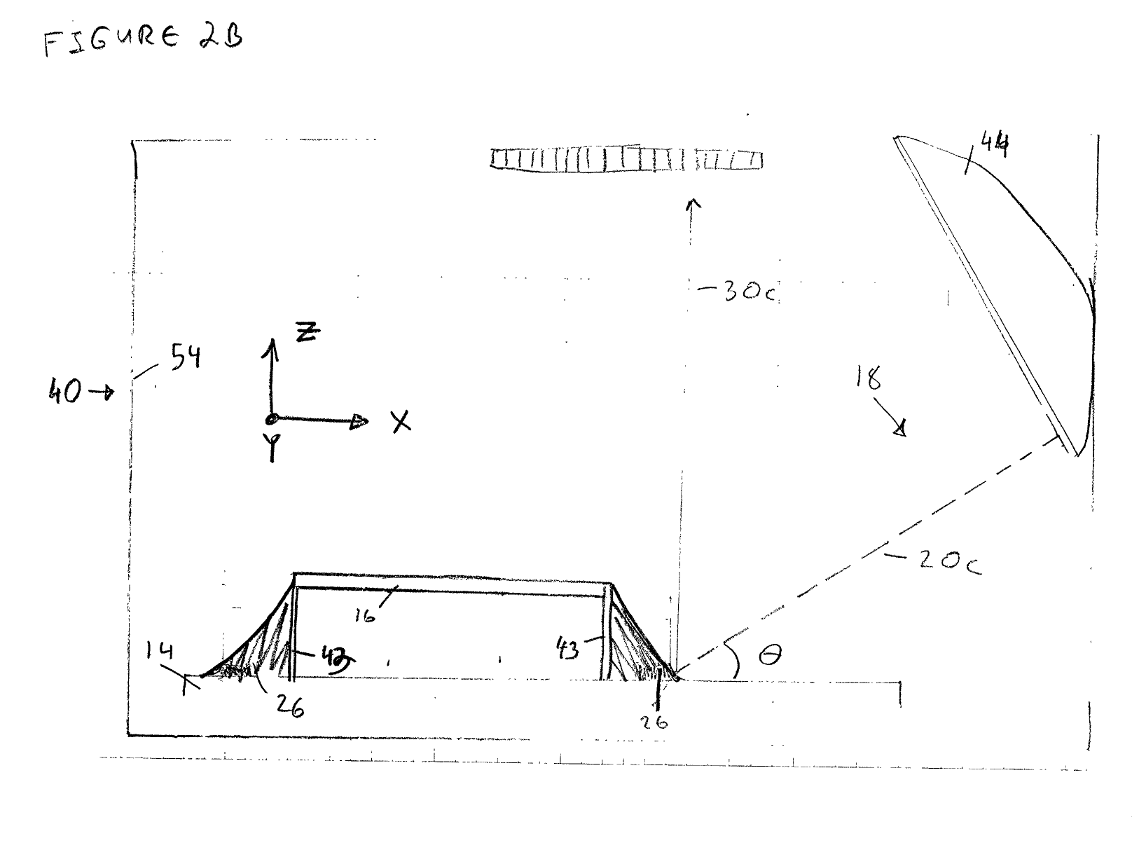

A second non-limiting embodiment of a device 40 of the present invention is depicted in FIGS. 2A and 2B. In FIG. 2A, an SMT component 16 with J-type leads 42 is mounted on UUT 14. Further, a source of collimated light 44 is mounted so as to project light beam 18 at an oblique angle Θ to UUT 14 whereas a light detector 46 is mounted to detect light reflected perpendicularly (parallel to the Z axis) to UUT 14. Θ can be any angle between 1° and 80° from horizontal to UUT 14. Θ is preferably between 30° and 60°, and even more preferably between 40° and 50° from horizontal to UUT 14.

The use of the second embodiment of device 40 of the present invention depicted in FIG. 2 in applying the method of the present invention is, in analogy to the embodiment of device 10, apparent to one skilled in the art. Accordingly, no further discussion relating to the manner of usage and operation will be provided. The only significant difference concerns the characteristics of the detected pattern of light reflected from J-type lead 42. It is clear to one skilled in the art that a J-type lead, such as 42, specularly reflects two rays: 30a from bend 44a, and 30c from soldering joint 26. Thus, in the case of a J-type lead, a pattern of two spots is be detected.

In order to increase the contrast of reflected light to background it is advantageous that UUT 14 be isolated from all sources of light excepting the light sources necessary for implementing the method present invention. In order to eliminate all sources of illumination excepting the illumination according to the present invention, UUT 14 is isolated from all sources of light excepting light source 44 by enclosure 54.

In FIG. 2B, an SMT component 16 with rectangular leads 42 is mounted on UUT 14 and inspected by device 40. It is clear to one skilled in the art that a rectangular lead, such as 43, specularly reflects only one ray, 30c from soldering joint 26. Thus, in the case of a rectangular lead 43, one light spot is detected.

Since according to the present invention any given lead produces only a very limited number of reflected light signals, the amount of data needed to confirm that a lead is properly attached to UUT 14 is very low. It is thus possible to configure a light source, 12 or 44, and a light detector, 22 or 46, so that a plurality of leads, 24, 42 or 43, on one side of a single component 16 or even facing one quadrant of a UUT 14 in its entirety is simultaneously illuminated. As a result a corresponding plurality of patterns of reflected light is detected. A row of gull-wing leads 24 is detected as three parallel rows of lights, a row of J-type leads 42 is detected as two parallel rows of lights, and a row of rectangular leads 43 is detected as a single row of lights. Simultaneous illumination of a plurality of leads and simultaneous detection of a corresponding plurality of reflections allows a quick and efficient inspection of all component leads on the surface of a UUT. Furthermore, when a row of a plurality of leads is inspected, a discrepancy from linearity or missing lights, corresponding to a mounting fault, are more obvious and easy to identify.

A third non-limiting and very useful embodiment of the present invention, device 48 is depicted in FIG. 3. UUT 14 is illuminated by four separate sources of collimated light 50a, 50b, 50c and 50d. Sources of light 50a, 50b, 50c and 50d are each mounted on carriage 51 connected to scanning mechanism 53 so as to illuminate UUT 14, each from a different quadrant. Further, sources of light 50a, 50b, 50c and 50d are each mounted so that incident light rays 20 impinge on UUT 14 at oblique angles Θ. In addition, light detector 52 is mounted on carriage 51. Scanning mechanism 53 is configured to transport carriage 52 in such a way that light detector 52 can inspect the entire surface of UUT 14. Further, scanning mechanism 53 is configured to transport carriage 52 in such a way so that light sources 50 can all illuminate the entire surface of UUT 14, each from a respective quadrant.

When UUT 14 is illuminated by light sources 50a, 50b, 50c and 50d, lead faces and solder joints facing all four quadrants specularly reflect light upwards 30, perpendicularly to UUT 14. Light detector 52, positioned above UUT 14, detects light reflected perpendicularly from the surface of UUT 14 to examine the integrity of illuminated leads.

During inspection, carriage 52 is brought to a location over UUT 14 that is to be inspected. In alternative embodiments of the present invention, light detector 52 is substantially fixed and a mechanism is provided to move UUT 14 relative to light detector 52.

Preferably, each of light sources 50 is activated in quick succession, for example 1 millisecond per light source. Simultaneously, light detector 50 is activated to detect reflected light 30. Although the activation in succession of light sources 50 can be done serially, in a preferred embodiment, each of light sources 50 is activated successively but not necessarily serially, as a function of the UUT topography.

Light detector 52 can be configured to acquire a plurality of images, each image corresponding to reflections 30 produced by one of light sources 50. In a preferred embodiment, light detector is configured to acquire a single composite image, corresponding to reflections 30 produced by all light sources 50 not concurrently. A method of applying this last preferred embodiment is when light detector 52 is a camera equipped with a telecentric lens. As is clear to one skilled in the art, the camera aperture is left open (B mode) while each one of the light sources 50 is activated in succession. In such a fashion, although each light source 50 illuminates features from a respective direction and the consequent reflections are acquired by light detector 52 at a different moment in time, reflections produced by illumination of all light sources 50 are acquired in the same image, easing analysis and increasing speed. As a result, an acquired image is a composite of separate illuminations from each one of the individual light sources.

In a further, less advantageous embodiment, light sources 50 can be activated simultaneously, illuminating UUT 14 from four different quadrants simultaneously. In such a case, light detector 52 acquires images from four quadrants simultaneously. This embodiment may lead to the formation of confusing and difficult to interpret light patterns.

As described hereinabove, each properly positioned gull-wing lead and respective solder joint reflects three light rays to be detected as three distinct spots of light. Each properly positioned J-type lead and respective solder joint reflects two light rays to be detected as two distinct spots of light. Each properly positioned rectangular lead and respective solder joint reflects one light ray to be detected as one distinct spot of light. It is important to note that there may be specific conditions, effects or embodiments of the present invention, whereby a properly positioned gull-wing, J-type or rectangular lead rather than producing three, two or one distinct spots respectively, produces a number or pattern of spots that is different. In analogy, there may be conditions, effects or embodiments of the present invention whereby inspection of a plurality of leads simultaneously does not lead to the detection of an image of one or more straight rows of lights or of two or more parallel rows of lights, but rather some other pattern. Other features on the surface of a UUT, not specifically discussed herein, may also produce distinctive and diagnostically useful reflections that can be detected by the method of the present invention. Such different and not herein discussed spots of light and patterns are considered to be within the scope of the present invention insofar as they are diagnostically useful.

It is clear to one skilled in the art that a device of the present invention, analogous in structure to device 48 depicted in FIG. 3, is not limited to four light sources and can be configured with any number of light sources, such as two or eight light of sources.

It is clear to one skilled in the art that a device of the present invention can be configured with a single light source, positioned in analogy to device 10 above UUT 14, but provided with a plurality of light detectors, positioned in analogy to the positioning of the individual light sources of device 48.

A fourth non-limiting embodiment of the present invention, device 54, is depicted in FIG. 4. UUT 14 is illuminated by a single annular source of collimated light 56. Light source 56 is mounted so as to illuminate the entirety of the surface of UUT 14 at one time. Further, light source 56 is mounted so that all light rays 20 impinge on UUT 14 at a common oblique angle Θ. When UUT 14 is illuminated by light source 56 all lead faces and solder joints specularly reflect light upwards 30, perpendicularly to UUT 14. Light detector 52 is mounted on carriage 53 so as to be able to inspect the surface of UUT 14 in its entirety. The use of device 54 in applying the method of the present invention is, in analogy to device 48, apparent to one skilled in the art. Accordingly, no further discussion relating to the manner of usage and operation will be provided.

One method to produce a broad collimated beam of light, suitable for the simultaneous illumination of a plurality of component leads is by placing a light-emitting diode or another appropriately configured light source at the focal point of a parabolic mirror, such as light source 12 in FIG. 1. Configuring a light detector such as a camera, linear CCD, CMOS array or a photocathode based device with a field of view sufficiently wide to detect light reflected from a plurality of component leads is well within the abilities of one skilled in the art. Configuring a light detector to be a directional light detector, for example by equipping the light detector with a telecentric lens is well within the abilities of one skilled in the art.

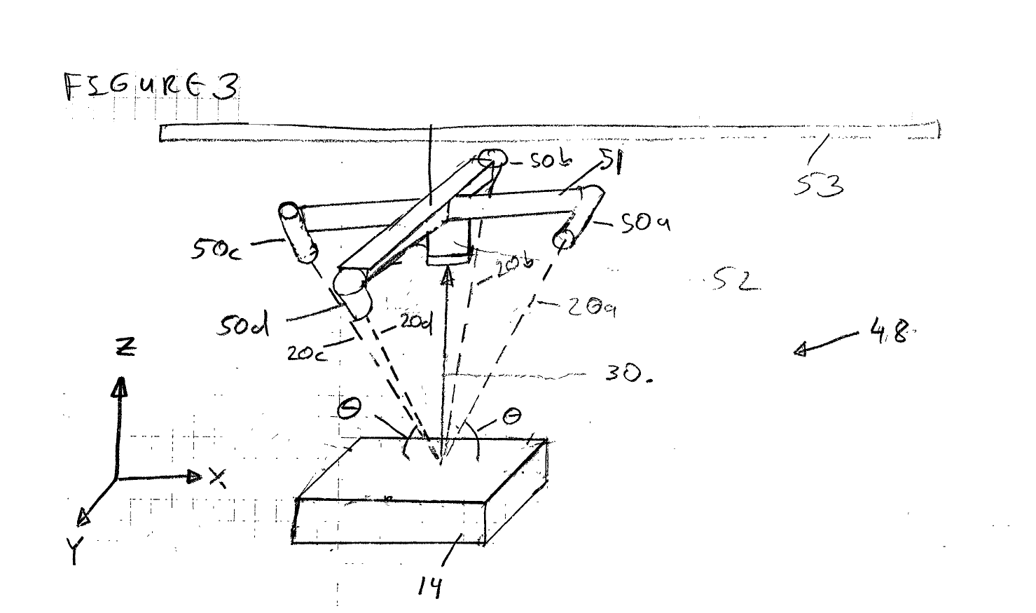

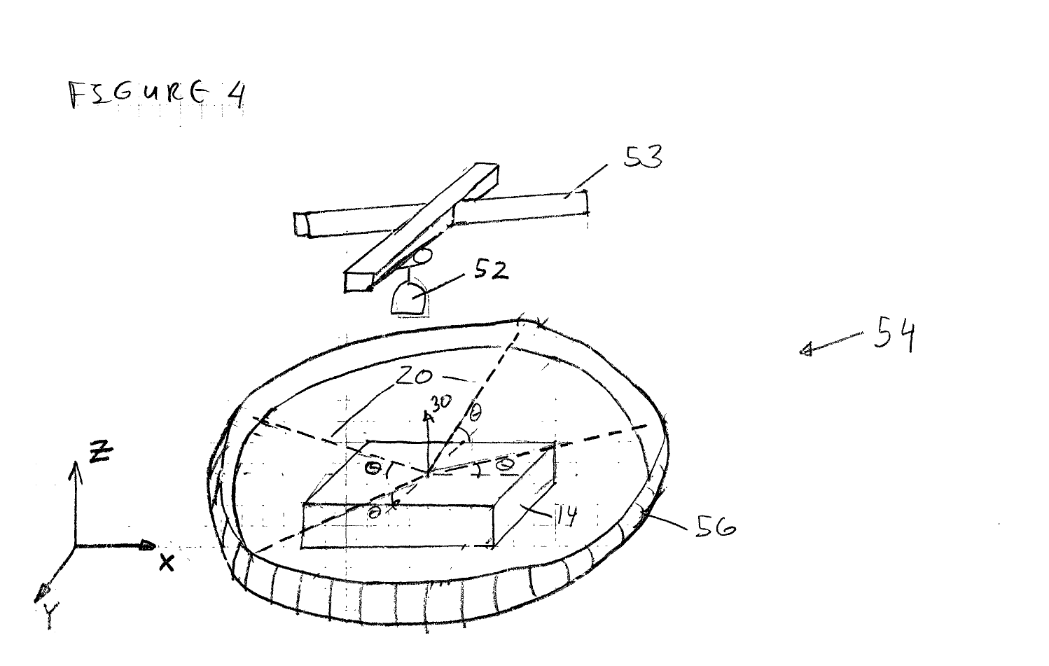

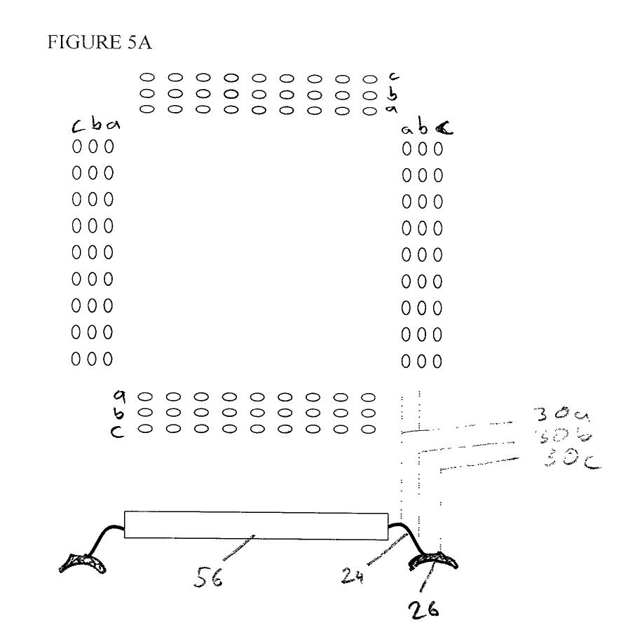

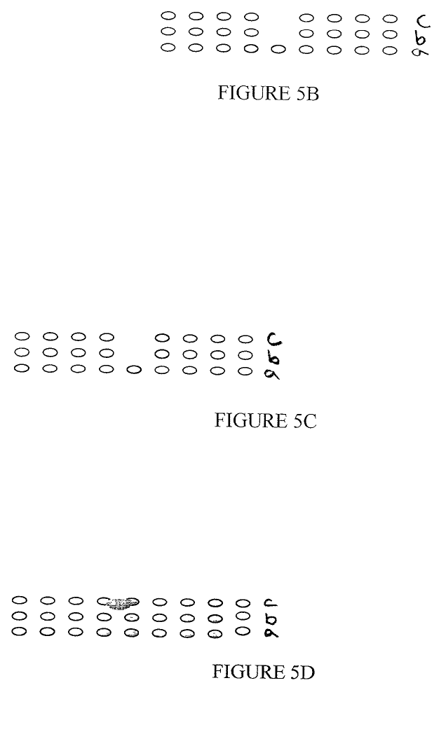

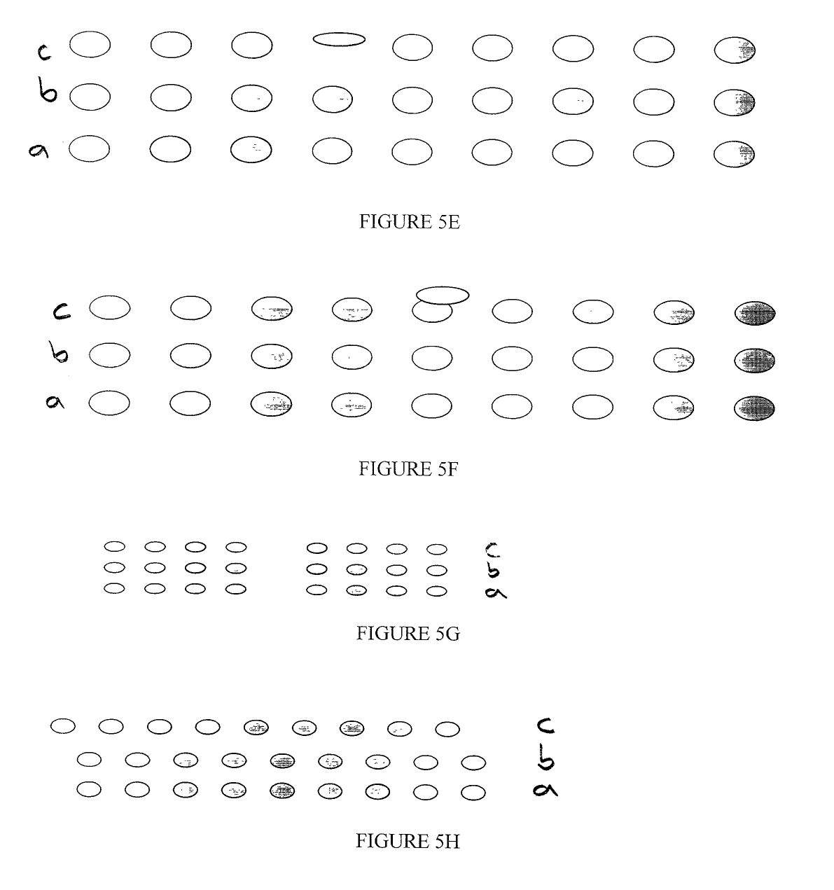

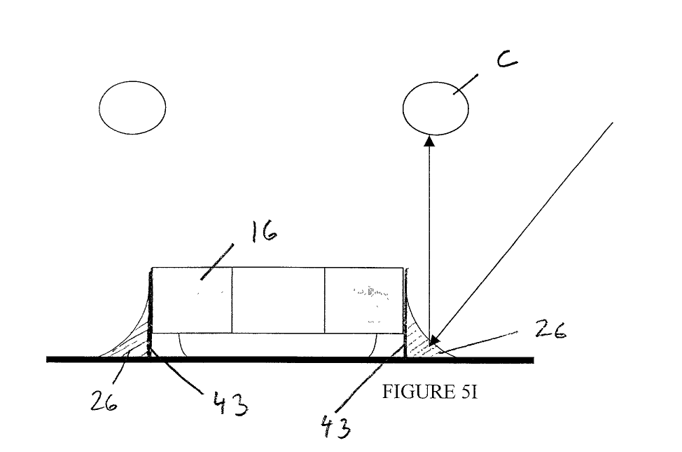

The method of the present invention can be better understood by examining images of component leads taken in accordance with the method of the present invention, in the first column of FIGS. 5A-5J. In FIG. 5, spots are referred to as c (reflected from the solder joint), b (reflected from a point of the lead proximate to the solder joint), and a (reflected from a point of the proximate to a component package).

In FIG. 5A, is depicted an image acquired according to the teachings of the present invention of a square component 56 with nine gull-wing leads on each of the fours sides of component 56. In FIG. 5A, component 56 is shown from a side-view to clarify how light rays 30 reflected from lead 24 and solder joint 26 correspond to spots of light. In FIG. 5A, the gull-wing leads on each one of the sides of component 56 each produce three rows of parallel light spots.

In FIG. 5B is depicted an image acquired according to the teachings of the present invention of a row of nine gull-wing leads. A missing spot c and a inwards shift in the location of the corresponding spot b relative to other spots b indicates an upwardly bent gull-wing lead.

In FIG. 5C a missing spot c and b indicates the presence of an inwardly bent gull-wing lead.

In FIG. 5D the presence of a bright spot between two spots c indicates a short circuit caused by excess solder.

In FIG. 5E the presence of an unexpectedly dim or small spot c indicates insufficient solder at one gull-wing lead.

In FIG. 5F the presence of an anomalously shaped spot c indicates excess solder at one gull-wing lead.

In FIG. 5G the absence of an expected set of three spots a, b and c indicates a broken gull-wing lead.

In FIG. 5H the deviation of spots c from colinearity with spots a and b indicates a misaligned component with gull-wing leads.

In FIG. 5I an image is reproduced of the bright spots produced by reflection from solder joint 26 of rectangular lead 43, spot c.

It is clear to one skilled in the art that many and various mounting faults, including those not specifically discussed hereinabove, each produce a different distinct pattern of lights which can be identified as such through the use of the method of the present invention. Further, it is clear to one skilled in the art that many devices, including the devices depicted in FIGS. 1, 2, 3 and 4 as well as other non-depicted embodiments of the device of the present invention can be used to realize the method of the present invention.

The teachings of the present invention can be applied to many different workpieces but the primary intended application as described herein concerns the inspection of components soldered onto a populated PCB. However, it is clear to one skilled in the art that the present invention is not limited to the embodiments described herein but also relates to all kinds of modifications thereof, insofar as they are within the scope of the claims.

What is claimed is:

1. A method for inspecting attachment of a component at a location on a workpiece comprising:
a. directing a collimated light beam at the location;
b. acquiring an image of said light specularly reflected from the workpiece; and
c. inspecting said image for a reflection pattern associated with the location.

2. The method of claim 1 wherein said light beam is directed at the location at an angle between about 1° and about 80° from perpendicular to the workpiece.

3. The method of claim 2 wherein said angle is between 30° and 60° from perpendicular to the workpiece.

4. The method of claim 3 wherein said angle is between 40° and 50° from perpendicular to the workpiece.

5. The method of claim 1 wherein said image of light is generated from light rays traveling in a substantially single unique direction.

6. The method of claim 1 wherein said image is acquired from light specularly reflected substantially perpendicular to the workpiece.

7. The method of claim 1 wherein collimated light beam is directed substantially perpendicular to the workpiece.

8. The method of claim 1 wherein said image is acquired from light reflected at an angle between about 1° and about 80° from perpendicular to the workpiece.

9. The method of claim 8 wherein said image is acquired from light reflected at an angle between 30° and 60° from perpendicular to the workpiece.

10. The method of claim 9 wherein said image is acquired from light reflected at an angle between 40° and 50° from perpendicular to the workpiece.

11. The method of claim 1 wherein said light beam is substantially monochromatic and includes substantially a limited range of frequencies and wherein said specularly reflected light is of substantially said limited range of frequencies.

12. The method of claim 1 wherein said reflection pattern corresponds to specular reflection from a lead and a respective slider joint of the component.

13. The method of claim 12 wherein said lead is a rectangular-lead and said reflection pattern includes one detected light spot.

14. The method claim 12 wherein said lead is a J-type lead and said reflection pattern includes two collinear detected light spots.

15. The method claim 12 wherein said lead is a gull-wing lead and said reflection pattern includes three collinear detected light spots.

16. The method of claim 1 wherein said reflection pattern corresponds to specular reflection from a plurality of leads and respective solder joints of the component.

17. The method of claim 16 wherein each of said leads is a rectangular-lead and said reflection pattern includes a straight row of detected light spots.

18. The method claim 16 wherein each of said leads is a J-type lead and said reflection pattern includes two parallel rows of detected light spots.

19. The method claim 16 wherein each of said leads is a gull-wing lead and said reflection pattern includes three parallel rows of detected light spots.

20. A device for inspecting a workpiece comprising:
a. a light source configured to illuminate at least part of the workpiece with collimated light; and
b. a light detection system configured to detect a pattern of light specularly reflected from the workpiece.

21. The device of claim 20 wherein said light detection system is a directional light detection system.

22. The device of claim 21 wherein said light detection system includes a telecentric lens.

23. The device of claim 20 wherein said light detection system is configured to detect said reflected light from only part of the workpiece at one time, the device further comprising:
c. a mechanism to move said light detection system and the workpiece relative to each other.

24. The device of claim 20 wherein said light source is configured to simultaneously illuminate substantially all of the workpiece.

25. The device of claim 20 wherein said light detection system is further configured to detect only a limited range of light frequencies.

26. The device of claim 20 wherein said light source is further configured to produce collimated light with only a limited range of light frequencies.

27. The device of claim 20 wherein said light detection system detects light reflected from the workpiece at an angle between 1° and 80° from an X-Y plane of the workpiece.

28. The device of claim 27 wherein said light detection system detects light reflected from the workpiece at an angle between 30° and 60° from said X-Y plane.

29. The device of claim 28 wherein said light detection system detects light reflected from the workpiece at an angle between 40° and 50° from said X-Y plane.

30. The device of claim 20 wherein said light source is configured so that said collimated light is projected substantially parallel to a Z-axis of the workpiece.

31. The device of claim 30 wherein said light detection system is configured to detect light reflected in a plurality of directions.

32. The device of claim 20 wherein said light source is configured so that said collimated light impinges the workpiece at an angle between 1° and 80° from an X-Y plane of the workpiece.

33. The device of claim 32 wherein said angle is between 30° and 60° from said X-Y plane.

34. The device of claim 33 wherein said angle is between 40° and 50° from said X-Y plane.

35. The device of claim 20 wherein said light detection system detects light reflected substantially in parallel to a Z-axis of the workpiece.

36. The device of claim 35 wherein said collimated light impinges the workpiece from a plurality of directions.

37. The device of claim 36 wherein impinging of said light occurs concurrently from said plurality of directions.

38. The device of claim 36 wherein said impinging of said light from each one of said plurality of directions occurs successively.

39. The device of claim 38 wherein said impinging of said light occurs from each one of said plurality of directions sequentially.
